(19) United States
(12) Patent Application Publication
(10) Pub. No.: US 2025/0306248 A1
(43) Pub. Date: Oct. 2, 2025

(54) OPTICAL ELEMENT AND APPARATUS

(71) Applicant: CANON KABUSHIKI KAISHA, Tokyo (JP)

(72) Inventors: KAZUHIRO HOSHINO, Tochigi (JP); TATSUKI ABE, Tochigi (JP)

(21) Appl. No.: 19/091,285

(22) Filed: Mar. 26, 2025

(30) Foreign Application Priority Data
Mar. 28, 2024 (JP) 2024-053578

(51) Int. Cl. G02B 1/115; G02B 1/12; G02B 5/08

(52) U.S. Cl. CPC G02B 1/115; G02B 1/12; G02B 5/0858

(57) ABSTRACT

An optical element includes a base member and an optical structure disposed on the base member. The optical structure includes an oxide layer and a fluoride layer. A distance between the oxide layer and the fluoride layer is smaller than a thickness of the fluoride layer. 0.095≤[Si]/([Si]+[Hf])<0.902 is satisfied where [Hf] is a hafnium content (at %) in the oxide layer, and [Si] is a silicon content (at %) in the oxide layer.

### BACKGROUND

### Technical Field

The present disclosure relates to an optical element including an oxide layer and a fluoride layer.

### Description of the Related Art

Since hafnium oxide is characterized by having high refractive index and permittivity, application to an optical element has been considered.

Japanese Patent Laid-Open No. 11-167003 discloses an antireflection film including a high-refractive-index layer and an intermediate-reflective-index layer under the high-refractive-index layer or a low-refractive-index layer on the high-refractive-index layer. In Japanese Patent Laid-Open No. 11-167003, examples of the material for forming the high-refractive-index layer include ZrO₂, HfO₂, Sc₂O₃, SiO₂, Al₂O₃, NdF₃, LaF₃, CaF₂, CeF₃, GdF₃, HoF₃, ErF₃, DyF₃, MgO, ThF₄, YF₃, YbF₃, BaF₃, and SrF₃. In Japanese Patent Laid-Open No. 11-167003, examples of the material for forming the intermediate-refractive-index layer include NdF₃, LaF₃, CaF₂, CeF₃, GdF₃, HoF₃, ErF₃, DyF₃, MgO, ThF₄, YF₃, YbF₃, BaF₃, and SrF₃. In Japanese Patent Laid-Open No. 11-167003, examples of the material for forming the low-refractive-index layer include MgF₂, Na₃AlF₆, LiF, BaF₃, SrF₃, CaF₂, NaF, and SiO₂.

### SUMMARY

An optical element according to an aspect of the present disclosure includes a base member and an optical structure disposed on the base member, wherein the optical structure includes an oxide layer and a fluoride layer, a distance between the oxide layer and the fluoride layer is smaller than a thickness of the fluoride layer, and 0.095≤[Si]/([Si]+[Hf])<0.902 is satisfied where [Hf] is a hafnium content (at %) in the oxide layer, and [Si] is a silicon content (at %) in the oxide layer.

Further features of the present disclosure will become apparent from the following description of exemplary embodiments with reference to the attached drawings.

### BRIEF DESCRIPTION OF THE DRAWINGS

FIGS. 1A to 1C are schematic sectional views illustrating optical elements.

FIG. 2 is a schematic diagram illustrating a sputtering film formation apparatus.

FIG. 3 is a diagram illustrating the absorptance.

FIG. 4 is a diagram illustrating the interfacial absorptance.

FIG. 5 is a diagram illustrating the absorptance.

FIG. 6 is a diagram illustrating the refractive index.

FIG. 7 is a diagram illustrating the transmittance of an antireflection film.

FIG. 8 is a diagram illustrating an exposure apparatus.

### DESCRIPTION OF THE EMBODIMENTS

The present inventors found that when a fluoride layer is stacked very close to a hafnium oxide layer, light absorption may occur between the hafnium oxide layer and the fluoride layer. Such light absorption deteriorates the optical characteristics, for example, transmittance and reflectance, and, therefore, can be reduced.

The embodiments according to the present disclosure will be described below with reference to the drawings. In this regard, in the following explanations and drawings, a configuration common to a plurality of drawings is denoted by a common reference.

Therefore, a common configuration will be explained referring to a plurality of drawings with each other and explanations of a configuration denoted by a common reference is appropriately omitted.

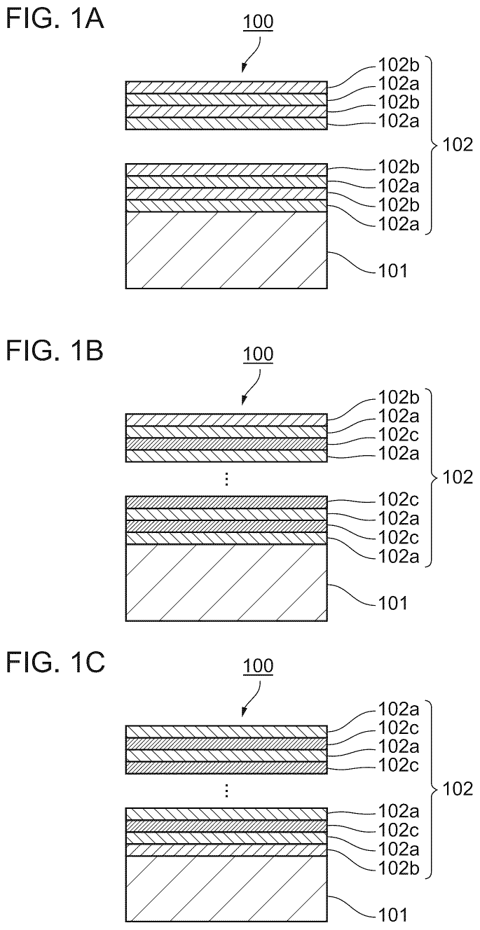

Each of FIGS. 1A to 1C is a schematic sectional view illustrating an optical element 100 according to the present embodiment. The optical element 100 includes a base member 101 and an optical structure 102 disposed on the base member 101. The optical structure 102 at least includes at least one oxide layer 102a and at least one fluoride layer 102b. The optical structure 102 is also referred to as a multilayer film. Herein, of the at least one oxide layer 102a and the at least one fluoride layer 102b, one oxide layer 102a and one fluoride layer 102b close to each other are noted. The distance between the noted oxide layer 102a and fluoride layer 102b is smaller than at least one of or preferably both the thickness of the noted oxide layer 102a and the thickness of the noted fluoride layer 102b. That is, the oxide layer 102a and the fluoride layer 102b being close to each other means that the distance therebetween is smaller than the thicknesses of themselves. Typically, the noted oxide layer 102a and fluoride layer 102b are in contact with each other and the distance between the noted oxide layer 102a and fluoride layer 102b is zero. The distance between the noted oxide layer 102a and fluoride layer 102b may be less than 10 nm. It is sufficient that there is at least one combination in which an oxide layer 102a is in contact with a fluoride layer 102b. Regarding the form with respect to the order of contact between the oxide layer 102a and the fluoride layer 102b, the fluoride layer 102b may be on the top of the oxide layer 102a, or the oxide layer 102a may be on the top of the fluoride layer 102b. However, a dielectric layer having smaller thickness than the noted oxide layer 102a and fluoride layer 102b may be interposed therebetween.

The oxide layer 102a contains hafnium and silicon. The hafnium content in the oxide layer 102a is denoted by [Hf] at %, and the silicon content in the oxide layer 102a is denoted by [Si] at %. The oxygen content in the oxide layer 102a is denoted by [O] at %. Herein, “at %” means “atomic percentage” and is a ratio of the number of specific atoms to the number of all atoms in an objective composition. The ratio may be expressed in “atomic %” or “atom %” instead of “at %”.

Regarding silicon and hafnium that are main components other than oxygen in the oxide layer 102a, the ratio of silicon to silicon and hafnium is denoted by [Si]/([Si]+[Hf]). The ratio is dimensionless, but the ratio is [Si]/([Si]+[Hf])×100% when being expressed in percentage. Hereafter [Si]/([Si]+[Hf]) is referred to simply as “silicon ratio”, and [Si]/([Si]+[Hf]) is distinguished from the silicon content denoted by [Si] at %. Since main metal components other than oxygen in the oxide layer 102a are a plurality of elements (silicon and hafnium), the oxide layer 102a may be referred to as a complex oxide layer or may be referred to as a metal oxide layer. In this regard, the fluoride layer 102b may be a simple metal fluoride layer but may be a complex fluoride layer in which main components other than fluorine in the fluoride layer 102b are a plurality of elements.

The oxide layer 102a can satisfy 0.095≤[Si]/([Si]+[Hf])<0.902. In particular, the oxide layer 102a can satisfy [Si]/([Si]+[Hf])≥0.219. The oxide layer 102a preferably satisfies [Si]/([Si]+[Hf])≤0.670 and more preferably satisfies [Si]/([Si]+[Hf])≥0.410. The oxide layer 102a preferably satisfies [Hf]≥3.2 at %, more preferably satisfies [Hf]≥10.5 at %, and further preferably satisfies [Hf]≥18.6 at %. The oxide layer 102a preferably satisfies [Hf]≤29.2 at % and more preferably satisfies [Hf]≤24.7 at %. The oxide layer 102a preferably satisfies [Si]≤29.3 at %, more preferably satisfies [Si]≤ 21.3 at %, and further preferably satisfies [Si]≤12.9 at %. The oxide layer 102a preferably satisfies [Si]≥3.1 at % and more preferably satisfies [Si]≥6.9 at %. The oxide layer 102a can satisfy 65.0 at %≤[O]≤68 at %.

The material used as the main component of the oxide layer 102a is an oxide containing hafnium (Hf), silicon (Si), and oxygen (O) as main components and is denoted by HfₓSi_{y}O_{z}. Hafnium oxide having a stoichiometric composition is HfO₂, [Hf]=33.3 at %, and [O]=66.6 at %. Silicon oxide having a stoichiometric composition is SiO₂, [Si]=33.3 at %, and [O]=66.7 at %. The oxide HfₓSi_{y}O_{z} may have an intermediate composition between HfO₂ and SiO₂. In this regard, in the following explanations, the oxide layer 102a containing hafnium (Hf), silicon (Si), and oxygen (O) as main components may be referred to as a hafnium silicon oxide layer or a silicon-containing hafnium oxide layer.

The oxide layer 102a containing silicon (Si), hafnium (Hf), and oxygen (O) as main components will be described. The respective contents of the elements other than hafnium, silicon, and oxygen contained in the oxide layer 102a are assumed to be M at % (M≥0) and N at % (N≥0). The sum of the hafnium content [Hf] at %, the silicon content [Si] at %, and the oxygen content [O] at % in the oxide layer 102a containing hafnium (Hf), silicon (Si), and oxygen (O) as main components is larger than M at % and N at % ([Si]+[Hf]+[O]>M and [Si]+[Hf]+[O]>N). The sum of the hafnium content [Hf] at %, silicon content [Si] at %, and the oxygen content [O] at % in the oxide layer 102a can be larger than the sum of the content of all elements other than hafnium, silicon, and oxygen contained in the oxide layer 102a. The sum of the content of all elements other than hafnium, silicon, and oxygen contained in the oxide layer 102a is 100−([Si]+[Hf]+[O]) at %. [Si]+[Hf]+[O]>100−([Si]+[Hf]+[O]). Thus [Si]+[Hf]+[O]>50.0 at %. In the oxide layer 102a, [Si]+[Hf]+[O] is 100 at % or less. In the oxide layer 102a, [Si]+[Hf]+[O] may be more than 50.0 at %. As described later, since the oxide layer 102a according to the present embodiment may contain elements (for example, Ar and Zr) other than hafnium, silicon, and oxygen, [Si]+[Hf]+[O] may be less than 100 at %. When the argon content in the oxide layer 102a is denoted by [Ar] at %, M═[Ar], and when the zirconium content in the oxide layer 102a is denoted by [Zr] at %, N═[Zr]. In the present exemplification, all elements other than hafnium, silicon, and oxygen are two types. However, all elements other than hafnium, silicon, and oxygen may be one type, three types, or four or more types.

Herein, use of a silicon-free hafnium oxide layer serving as an oxide layer instead of the oxide layer 102a that is a silicon-containing hafnium oxide layer is considered. When a fluoride layer is arranged close to the silicon-free hafnium oxide layer, silicon in the fluoride layer is taken away by the silicon-free hafnium oxide layer, and an altered layer that tends to absorb light may be formed between the silicon-free hafnium oxide layer and the fluoride layer. In this regard, the silicon-containing hafnium oxide layer according to the present embodiment being used suppresses such an altered layer from being formed. As a result, light absorption between the oxide layer and the fluoride layer is reduced and an optical element having favorable optical characteristics is realized.

The oxide layer 102a may satisfy 0.9 at %≤[Ar]<2.0 at %. The oxide layer 102a may satisfy 0.01 at %≤[Zr]<0.14 at %. Even when the oxide layer 102a contains elements (for example, Ar and Zr) other than hafnium, silicon, and oxygen, favorable optical characteristics are obtained provided that the concentration thereof is such an extent. The oxide layer 102a preferably satisfies [Hf]+[Si]+[O]≥97.0 at % and more preferably satisfies [Hf]+[Si]+[O]≥98.0 at %. The oxide layer 102a may satisfy [Hf]+ [Si]+[O]≤99.2 at % or may satisfy [Hf]+ [Si]+[O]≤98.7 at %. In the oxide layer 102a according to the present embodiment, carbon is not necessarily positively added to the oxide layer 102a, and the carbon content [C] at % in the oxide layer 102a is preferably less than 1 at % and preferably 0.1 at % or less. In the oxide layer 102a according to the present embodiment, hydrogen being added to the oxide layer 102a enables absorption (extinction coefficient) and the refractive index of the oxide layer 102a to be controlled. The hydrogen content [H] in the oxide layer 102a may be 0.1 at % or more or may be 1 at % or more. In the present embodiment, it is not necessary that hydrogen be positively introduced into the oxide layer 102a, and the hydrogen content [H] at % in the oxide layer 102a may be less than 0.1 at %. In this regard, a portion of oxygen in the oxide layer 102a may be substituted with hydrogen, and less than 15 at % of hydrogen on a hydrogen content [H] at % basis may be introduced. In addition, the crystallinity of the oxide layer 102a being controlled enables absorption to be controlled, and to reduce absorption, the oxide layer 102a can be amorphous rather than crystalline.

Examples of the material used for the fluoride layer 102b include materials containing magnesium fluoride (MgF₂) as a main component, but the material is not limited to this. For example, fluoride materials, such as MgF₂, Na₃AlF₆, LiF, BaF₃, SrF₃, CaF₂, NaF, and AlF₃, may be used, or mixtures or compounds formed of two or more of these may be used.

In the optical structure 102 illustrated in FIG. 1A, a plurality of oxide layers 102a and a plurality of fluoride layers 102b are alternately stacked. In this regard, the optical structure 102 illustrated in FIG. 1A has a configuration in which the oxide layers 102a and the fluoride layers 102b are successively alternately stacked from the base member 101 so that the outermost layer is the fluoride layer 102b. However, the configuration may be changed in accordance with the application of the optical element. For example, a form in which the fluoride layers 102b and the oxide layers 102a are successively alternately stacked from the base member 101 may be adopted, and further, a configuration in which the fluoride layer 102b serving as the outermost layer is added thereto may be adopted. Herein, first type layers and second type layers being alternately stacked means a state in which at least one second type layer is located between two first type layers, and at least one first type layer is located between two second type layers. Therefore, to alternately stack the first type layer and the second type layer, at least two layers are necessary. The optical structure 102 does not necessarily have an alternately layered structure in which only the fluoride layer 102b and the oxide layer 102a are alternately stacked. The optical structure 102 may be composed of one oxide layer 102a and one fluoride layer 102b. In this regard, a protective layer serving as the outermost layer may be disposed on the outermost fluoride layer 102b, a dielectric layer having an intermediate refractive index may be interposed between the oxide layer 102a and the fluoride layer 102b, or an adhesive layer may be disposed between the base member 101 and the optical structure 102.

In the optical structures 102 illustrated in FIGS. 1B and 1C, the oxide layers 102a and dielectric layers 102c having a lower refractive index than the oxide layer 102a are alternately stacked. Each of the plurality of dielectric layers 102c is, for example, a silicon oxide layer. However, the dielectric layer 102c is not limited to this and may be an oxide, a nitride, or a carbide of various metal elements or semimetal elements. For example, the dielectric layer 102c may be aluminum oxide, silicon oxide, or yttrium oxide. In this regard, silicon is a semimetal element and, therefore, is a metal component, and aluminum oxide, silicon oxide, or yttrium oxide may be referred to as a metal oxide layer. In addition, the dielectric layer 102c may be a simple oxide layer but may be a complex oxide layer in which main components other than oxygen in the dielectric layer 102c are a plurality of elements.

Regarding the examples illustrated in FIGS. 1A, 1B, and 1C, four oxide layers 102a serving as the plurality of oxide layers 102a are illustrated in the drawing. From the top (far side from the base member 101), the four layers are called the first oxide layer 102a from the top, the second oxide layer 102a from the top, the second oxide layer 102a from the bottom, and the first oxide layer 102a from the bottom, respectively.

Regarding the example illustrated in FIG. 1A, four fluoride layers 102b serving as the plurality of fluoride layers 102b are illustrated in the drawing. From the top (far side from the base member 101), the four layers are called the first fluoride layer 102b from the top, the second fluoride layer 102b from the top, the second fluoride layer 102b from the bottom, and the first fluoride layer 102b from the bottom, respectively. In the optical structure 102 illustrated in FIG. 1A, the fluoride layer 102b is disposed close to (in the present example, in contact with) every oxide layer 102a. Therefore, since the fluoride layer 102b is present close to every oxide layer 102a, any fluoride layer 102b may be noted. For example, the plurality of oxide layers 102a include the noted first oxide layer 102a from the top and the second oxide layer 102a from the bottom different from the first oxide layer 102a from the top. The plurality of fluoride layers 102b include the noted second fluoride layer 102b from the top and the first fluoride layer 102b from the bottom different from the second fluoride layer 102b from the top. The second fluoride layer 102b from the top is located between the first oxide layer 102a from the top and the base member 101. The second oxide layer 102a from the bottom is located between the second fluoride layer 102b from the top and the base member 101. The first fluoride layer 102b from the bottom is located between the second oxide layer 102a from the bottom and the base member 101.

In the optical structure 102 illustrated in FIG. 1B, the fluoride layer 102b is disposed close to (in the present example, in contact with) the first oxide layer 102a from the top. Therefore, it is sufficient that the first oxide layer 102a from the top and the fluoride layer 102b close thereto are noted. The optical structure 102 includes the noted first oxide layer 102a from the top and the second oxide layer 102a from the top different from the first oxide layer 102a from the top. The first oxide layer 102a from the top is located between the fluoride layer 102b and the base member 101, and the second oxide layer 102a from the top is located between the first oxide layer 102a from the top and the base member 101. The dielectric layer 102c having a lower refractive index than the first oxide layer 102a from the top and the second oxide layer 102a from the top is located between the first oxide layer 102a from the top and the second oxide layer 102a from the top. The dielectric layer 102c having a lower refractive index than the second oxide layer 102a from the top and the second oxide layer 102a from the bottom is located between the second oxide layer 102a from the top and the second oxide layer 102a from the bottom. The first oxide layer 102a from the bottom is located between the second oxide layer 102a from the bottom and the base member 101. The dielectric layer 102c having a lower refractive index than the second oxide layer 102a from the bottom and the first oxide layer 102a from the bottom is located between the second oxide layer 102a from the bottom and the first oxide layer 102a from the bottom. The first oxide layer 102a from the bottom is in contact with the base member 101.

In the optical structure 102 illustrated in FIG. 1C, the fluoride layer 102b is disposed close to (in the present example, in contact with) the first oxide layer 102a from the bottom. Therefore, it is sufficient that the first oxide layer 102a from the bottom and the fluoride layer 102b close thereto are noted. The fluoride layer 102b is disposed between the first oxide layer 102a from the bottom and the base member 101. The fluoride layer 102b is in contact with the base member 101.

The base member 101 may be formed of a material, for example, optical glass such as calcium fluoride crystal, quartz glass, and borosilicate crown glass, resin, and metal. In this regard, the base member 101 having various shapes, such as a flat surface shape and a shape with a curved surface, may be used in accordance with the application and the type (for example, a lens, a mirror, a filter, and a prism). For example, in the base member 101, the optical structure 102 side surface may be a concave surface or a convex shape. Consequently, a concave lens, a convex lens, a concave mirror, a convex mirror, and the like are realized.

The high-refractive-index film according to the present embodiment is widely applicable to coating of optical elements including a lens, a filter, a mirror, a prism, an image sensor, and a display. Further, the high-refractive-index film is usable for optical apparatuses including the optical element, such as exposure apparatuses, various types of cameras, and interchangeable lenses. These optical apparatuses may include a plurality of optical parts including the optical element coated with a film having a configuration in which a hafnium silicon oxide layer is in contact with a magnesium fluoride layer and, in addition, a holding part (lens barrel) holding a plurality of optical parts. The high-refractive-index film according to an embodiment and a low-refractive-index film having a lower refractive index than the high-refractive-index film being stacked enables a high-performance antireflection structure or a reflection structure to be formed. For example, in an exposure apparatus including an ultraviolet light source, a lens being provided with the antireflection structure according to an embodiment and/or a mirror being provided with the reflection structure according to the embodiment enables the exposure performance of the exposure apparatus which uses the ultraviolet light to be improved.

The optical element 100 is applicable to various optical apparatuses. Examples of the optical apparatus including the optical element 100 include camera lenses, telescopes, projectors, exposure apparatuses, and measuring instruments. In particular, the optical element 100 is suitable for optical apparatuses including a light source, such as projectors, exposure apparatuses, and measuring instruments. A layered film 20 of an optical apparatus 30 being designed in accordance with the wavelength of a light source enables the optical element 100 to transmit and/or reflect the light from the light source. The light from the light source may be any one of infrared light, visible light, and ultraviolet light. Many fluorides absorb a smaller amount of ultraviolet light than other metal compounds and, therefore, are suitable when the light source is the ultraviolet light.

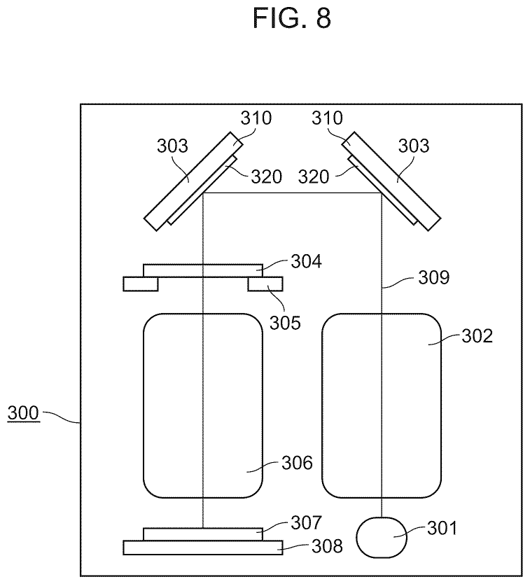

FIG. 8 is a schematic diagram illustrating an exposure apparatus as an example of an optical apparatus EQP. The optical apparatus 300 serving as an exposure apparatus includes a light source 301, an illumination optical system 302, and a mirror unit 303 composed of a mirror holding unit and a mirror. In addition, the optical apparatus 300 includes a reticle stage 305 to support a reticle 304, a projection optical system 306 to project a pattern of the reticle 304, and a substrate stage 308 to support a substrate 307. The exposure light 309 from the light source 301 is reflected by the mirror 320 of the illumination optical system and is guided to the reticle 304, and the exposure light 309 with the pattern of the reticle 304 is condensed by the projection optical system 306 and is projected on the substrate 307. The pattern formed on the reticle 304 by the light source 301 and the optical element 100 is projected on the substrate 307. The substrate 307 is coated with a photoresist, and the photoresist is exposed to the exposure light 309. The substrate 307 may be a semiconductor wafer or may be a glass substrate for a flat panel display (FPD). Typically, the exposure light 309 of the exposure apparatus is ultraviolet light. The wavelength of the exposure light 309 is 436 nm for a g-line light source or about 365 nm for an i-line light source. The wavelength of the exposure light is about 248 nm for a KrF excimer laser light source, about 193 nm for an ArF excimer laser light source, or 10 to 20 nm for an EUV (extreme ultraviolet radiation) light source. In the above-described example, the optical element 100 is adopted as the lenses of the illumination optical system 302 and the projection optical system 306, but the optical element 100 may be adopted as the mirror 320. Alternatively, the projection optical system may be composed of a mirror, and the optical element 100 may be adopted as the mirror. The projection optical system may be a reduction projection type, may be an equal-magnification projection type, or may be a magnified-projection type. Herein, a transmission type reticle 304 is exemplified, but a reflection type reticle 304 may be used. The projection optical system 306 may be a refraction type by using a lens or may be a reflection type by using a mirror. The optical element 100 may be used for a mirror of a reflection type reduction projection optical system equipped in an exposure apparatus including an EUV light source.

### EXAMPLES

A manufacturing method of the optical element 100 (optical part) according to the present embodiment including the optical structure 102 having a configuration in which the oxide layer 102a is in contact with the fluoride layer 102b will be described. In the following explanations, the oxide layer 102a is a hafnium silicon oxide layer, and the fluoride layer 102b is a magnesium fluoride layer. An oxide layer compared with the oxide layer 102a that is the hafnium silicon oxide layer is a hafnium oxide layer or a silicon oxide layer.

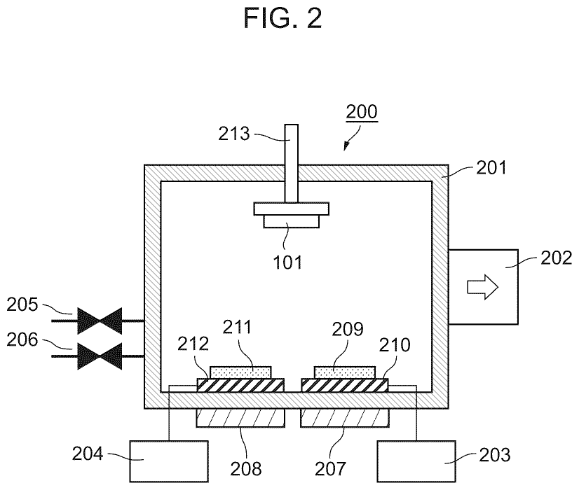

FIG. 2 is a schematic diagram illustrating a sputtering film formation apparatus 200 used for producing the optical element. The sputtering film formation apparatus 200 includes a vacuum chamber 201 serving as an airtight container and an exhaust system 202 to evacuate the interior of the vacuum chamber 201. In addition, to introduce gas necessary for film formation into the vacuum chamber 201, an argon gas introduction port 205 and an oxygen gas introduction port 206 are included. Further, a first sputtering target 209, a backing plate 210, and a magnet mechanism 207 are disposed so as to be attached to the vacuum chamber 201. In addition, a second sputtering target 211, a backing plate 212, a magnet mechanism 208, and a base member holding mechanism 213 are disposed so as to be attached to the vacuum chamber 201. The base member 101 of the optical element being held by the base member holding mechanism 213 and an electric power being applied from power supplies 203 and 204 enable film formation to be performed by a reactive sputtering method.

To form the hafnium silicon oxide layer, film formation is performed by the reactive sputtering method in the following procedure. For example, a base member 101 composed of synthesized quartz glass worked into a predetermined optical element shape is disposed. In addition, for example, 3 inch of hafnium metal (purity of 99.9% by weight or more) serving as the sputtering target 209 and 3 inch of polysilicon (conductive silicon doped with boron) serving as the sputtering target 211 are set in the vacuum chamber 201. In such an instance, the surface-to-surface vertical distance between the surface of the base member 101 and the target surface of the sputtering targets 209 and 211 is set to be, for example, 200 mm. In this regard, two targets 209 and 211 are arranged at positions symmetric with respect to the central axis of the base member holding mechanism 213, and the distance between the central axis of the base member holding mechanism 213 and the central axis of each of the targets 209 and 211 is set to be, for example, 100 mm. Subsequently, for example, the interior of the vacuum chamber 201 is evacuated until the pressure reaches the degree of vacuum of about 6×10⁻⁵ Pa by using the exhaust system 202 having a displacement of 1,500 L/sec. In such a state, plasma discharge is performed while an argon gas is introduced from the argon gas introduction port 205 and an oxygen gas is introduced from the oxygen gas introduction port 206. That is, an electric power is applied from the power supplies 203 and 204 to the sputtering targets 209 and 211 so as to generate plasma discharge and to form a hafnium silicon oxide layer having a thickness of about 100 nm on the base member 101 having, for example, a diameter of 30 mm and a thickness of 2 mm. In this regard, the thickness of each layer is not limited to being about 100 nm and is appropriately set in accordance with the wavelength of the light handled in the optical element and the number of the layers constituting the optical structure. The thickness of the hafnium silicon oxide layer in the optical element is, for example, 10 to 1,000 nm or, for example, 10 to 100 nm. The hafnium silicon oxide layers having a thickness of 100 nm may be stacked without interposing another layer therebetween so as to serve as the hafnium silicon oxide layer having a thickness of 1,000 nm. Thereafter, a magnesium fluoride layer having a thickness of about 100 nm is formed on the hafnium silicon oxide layer by a known film formation method so as to produce a two-layer film. Explanations will be provided below with reference to specific Examples and Comparative examples. In this regard, explanations of formation of the magnesium fluoride layer will be omitted since a known film formation method is usable.

### Example 1 to Example 6 and Comparative Example 1 to Comparative Example 3

A two-layer film serving as an optical structure composed of an oxide layer and a fluoride layer will be described with reference to Example 1 to Example 6 and Comparative example 1 to Comparative example 3. The oxide film serving as a lower layer of the two-layer film was formed, and a magnesium fluoride layer (MgF₂) was formed on the oxide layer so as to come into contact with the oxide layer. The oxide layers in Example 1 to Example 6 and Comparative example 1 to Comparative example 3 differ from each other. Regarding all hafnium silicon oxide layers according to Example 1 to Example 6 and Comparative example 2, a hafnium oxide layer according to Comparative example 1, and a silicon oxide layer according to Comparative example 3, film formation was performed by introducing an argon gas from the argon gas introduction port 205 at a flow rate of 65 sccm. In each Example and each Comparative example, film formation was performed by introducing an oxygen gas from the oxygen gas introduction port 206 at a flow rate within the range of 10 to 16 sccm. In addition, in Example 1 to Example 6 and Comparative example 2, the silicon ratio ([Si]/([Si]+[Hf])) was adjusted by changing the ratio of the applied electric power of the power supply 204 to that of the power supply 203. In this regard, the above-described condition is an exemplification, and, for example, film formation of the hafnium silicon oxide layer may be performed using a sputtering target material containing hafnium and silicon at a predetermined ratio. To form a film in which the silicon ratio ([Si]/([Si]+[Hf])) is changed, film formation may be performed by preparing a sputtering target containing hafnium and silicon at another ratio. Regarding the hafnium silicon oxide layer in each Example and each Comparative example, the silicon ratio ([Si]/([Si]+[Hf])) and the refractive index were evaluated. In addition, the light absorptance and the interfacial absorptance of the two-layer film composed of the hafnium silicon oxide layer and the magnesium fluoride layer were evaluated.

The hafnium silicon oxide layer was irradiated with a MeV order of high-energy ion beam and the content of each element in the film was evaluated by the technique of the Rutherford backscattering spectrometry (RBS). These results were used, and the hafnium content [Hf] at %, the silicon content [Si] at %, and the oxygen content [O] at % contained in the hafnium silicon oxide layer were determined.

The light absorptance and the refractive index were evaluated by using an UV-Vis-NIR spectrophotometer and measuring the transmittance and the reflectance in the wavelength range of 200 nm to 500 nm at a light inlet angle of 5 degrees.

The light absorptance was calculated by the following mathematical expression.

$$A ( \% ) = 100 - T ( \% ) - R ( \% ) \qquad ( expression 1 )$$

Herein, A (%) represents light absorptance, T (%) represents transmittance, and R (%) represents reflectance.

The refractive index was calculated analyzing the measured reflectance by using optical thin film analysis-design software Film Wizard™ produced by Scientific Computing International.

To evaluate an aptitude as an optical element for an exposure apparatus to handle wavelengths in an ultraviolet band, such as the DUV (Deep UV; e.g. a wavelength of 200-300 nm), the i-line, the g-line, and the h-line, an average value of the light absorptance (%) in the wavelength of 280 to 450 nm was evaluated. In addition, a value got by subtracting the light absorptance of a single layer film of the hafnium silicon oxide layer and the light absorptance of a single layer film of the magnesium fluoride from the light absorptance of the two-layer film composed of the hafnium silicon oxide layer and the magnesium fluoride layer was calculated. This was defined as an interfacial absorptance at the interface between the hafnium silicon oxide layer and the magnesium fluoride layer and was evaluated. Therefore, the interfacial absorptance may take on a negative value. The refractive index was evaluated where the light with a wavelength of 280 nm was taken as the reference. As a matter of course, when an optical element is used for an application different from this, the evaluation may be performed where a wavelength suitable for the application is taken as the reference. The wavelength suitable for the optical element is not limited to a wavelength in the ultraviolet band, may be a wavelength in the visible light band, or may be a wavelength in the infrared band.

Regarding the evaluation of the adhesiveness (abrasion resistance) after film formation of the two-layer film, lens-cleaning paper was impregnated with a solvent of OHC solvent, a sample was subjected to a rubbing test including 50 times of reciprocation under a load of 500 g, and appearance evaluation (presence or absence of film peeling and film scratch) was performed. When neither peeling nor scratch of the film was observed, the sample was rated as A, and when peeling or scratch of the film was observed, the sample was rated as B.

Regarding the evaluation of the environmental durability after film formation of the two-layer film, a sample was left to stand in a high-temperature high-humidity environment (60° C., 90%, and 100 h), and thereafter, appearance evaluation (presence or absence of film peeling and film scratch) was performed. When neither peeling nor scratch of the film occurred, the sample was rated as A, when cracking of the film was observed, the sample was rated as B, and when peeling of the film was observed, the sample was rated as C.

Regarding Example 1 to Example 6 and Comparative example 1 to Comparative example 3, the compositions of the hafnium silicon oxide layer (Example 1 to Example 6 and Comparative example 2), the hafnium oxide layer (Comparative example 1), and the silicon oxide layer (Comparative example 3) are presented in Table 1. The evaluation results of the two-layer film of the magnesium fluoride layer and the hafnium silicon oxide layer (Example 1 to Example 6 and Comparative example 2), the hafnium oxide layer (Comparative example 1), or the silicon oxide layer (Comparative example 3), which are presented in Table 1, are presented in Table 2.

TABLE 1

| | [Si] | [Hf] | [O] | [Ar] | [Zr] | ([Si] + [Hf] | [Si]/ |
|---|---|---|---|---|---|---|---|
| | at % | at % | at % | at % | at % | [O]) at % | ([Si] + /Hf]) |
| Example 1 | 3.1 | 29.2 | 65.9 | 1.8 | 0.12 | 98.2 | 0.095 |
| Example 2 | 5.3 | 26.3 | 66.5 | 1.7 | 0.11 | 98.1 | 0.168 |
| Example 3 | 6.9 | 24.7 | 66.4 | 1.7 | 0.1 | 98.0 | 0.219 |
| Example 4 | 12.9 | 18.6 | 67.1 | 1.4 | 0.08 | 98.6 | 0.410 |
| Example 5 | 21.3 | 10.5 | 66.9 | 1.2 | 0.04 | 98.7 | 0.670 |
| Example 6 | 29.3 | 3.2 | 66.7 | 0.9 | 0.01 | 99.2 | 0.902 |
| Comparative example 1 | 0.0 | 32.0 | 65.3 | 2.5 | 0.14 | 97.3 | 0.000 |
| Comparative example 2 | 1.2 | 31.5 | 65.1 | 2.0 | 0.14 | 97.8 | 0.037 |
| Comparative example 3 | 33.1 | 0.0 | 66.6 | 0.5 | 0.00 | 99.7 | 1.000 |

TABLE 2

| | | | Refractive | Adhesiveness | |
|---|---|---|---|---|---|
| | Light | Interfacial | index of | or abrasion | Environmental |
| | absorptance % | absorptance % | oxide layer | resistance | durability |
| Example 1 | 0.30 | 0.09 | 2.157 | A | A |
| Example 2 | 0.23 | 0.02 | 2.131 | A | A |
| Example 3 | 0.19 | 0.00 | 2.050 | A | A |
| Example 4 | 0.12 | −0.05 | 1.902 | A | A |
| Example 5 | 0.13 | −0.06 | 1.840 | A | A |
| Example 6 | 0.08 | −0.08 | 1.538 | A | B |
| Comparative | 0.60 | 0.38 | 2.249 | A | A |
| example 1 | | | | | |
| Comparative | 0.49 | 0.26 | 2.164 | A | A |
| example 2 | | | | | |
| Comparative | 0.03 | −0.04 | 1.514 | B | C |
| example 3 | | | | | |

The silicon ratio ([Si]/([Si]+[Hf])) in Example 1 was 0.095. The oxygen atom content in the hafnium silicon oxide layer in Example 1 was 65.9 at %. In addition, the average value of the light absorptance of the two-layer film composed of the hafnium silicon oxide layer and the magnesium fluoride layer in Example 1 at a wavelength of 280 to 450 nm was 0.30%, the average value of the interfacial absorptance at a wavelength of 280 to 450 nm was 0.09%, and the refractive index at a wavelength of 280 nm was 2.157. There was no problem with respect to the results of both the adhesiveness and the environmental resistance.

The silicon ratio ([Si]/([Si]+[Hf])) in Example 2 was 0.168. The oxygen atom content in the hafnium silicon oxide layer in Example 2 was 66.5 at %. In addition, the average value of the light absorptance of the two-layer film composed of the hafnium silicon oxide layer and the magnesium fluoride layer in Example 2 at a wavelength of 280 to 450 nm was 0.23%, the average value of the interfacial absorptance at a wavelength of 280 to 450 nm was 0.02%, and the refractive index at a wavelength of 280 nm was 2.131. There was no problem with respect to the results of both the adhesiveness and the environmental resistance.

The silicon ratio ([Si]/([Si]+[Hf])) in Example 3 was 0.219. The oxygen atom content in the hafnium silicon oxide layer in Example 3 was 66.4 at %. In addition, the average value of the light absorptance of the two-layer film composed of the hafnium silicon oxide layer and the magnesium fluoride layer in Example 3 at a wavelength of 280 to 450 nm was 0.19%, the average value of the interfacial absorptance at a wavelength of 280 to 450 nm was 0.00%, and the refractive index at a wavelength of 280 nm was 2.050. There was no problem with respect to the results of both the adhesiveness and the environmental resistance.

The silicon ratio ([Si]/([Si]+[Hf])) in Example 4 was 0.410. The oxygen atom content in the hafnium silicon oxide layer in Example 4 was 67.1 at %. In addition, the average value of the light absorptance of the two-layer film composed of the hafnium silicon oxide layer and the magnesium fluoride layer in Example 4 at a wavelength of 280 to 450 nm was 0.18%, the average value of the interfacial absorptance at a wavelength of 280 to 450 nm was-0.05%, and the refractive index at a wavelength of 280 nm was 1.902. There was no problem with respect to the results of both the adhesiveness and the environmental resistance.

The silicon ratio ([Si]/([Si]+[Hf])) in Example 5 was 0.670. The oxygen atom content in the hafnium silicon oxide layer in Example 5 was 66.9 at %. In addition, the average value of the light absorptance of the two-layer film composed of the hafnium silicon oxide layer and the magnesium fluoride layer in Example 5 at a wavelength of 280 to 450 nm was 0.13%, the average value of the interfacial absorptance at a wavelength of 280 to 450 nm was-0.06%, and the refractive index at a wavelength of 280 nm was 1.840. There was no problem with respect to the results of both the adhesiveness and the environmental resistance.

The silicon ratio ([Si]/([Si]+[Hf])) in Example 6 was 0.902. The oxygen atom content in the hafnium silicon oxide layer in Example 6 was 66.7 at %. In addition, the average value of the light absorptance of the two-layer film composed of the hafnium silicon oxide layer and the magnesium fluoride layer in Example 6 at a wavelength of 280 to 450 nm was 0.08%, the average value of the interfacial absorptance at a wavelength of 280 to 450 nm was-0.08%, and the refractive index at a wavelength of 280 nm was 1.538. There was no problem with respect to the adhesiveness, but with respect to the result of the environmental resistance, cracking occurred slightly.

The silicon ratio ([Si]/([Si]+[Hf])) in Comparative example 1 was 0.000. The oxygen atom content in the hafnium oxide layer in Comparative example 1 was 65.3 at %. In addition, the average value of the light absorptance of the two-layer film composed of the hafnium oxide layer and the magnesium fluoride layer in Comparative example 1 at a wavelength of 280 to 450 nm was 0.60%, the average value of the interfacial absorptance at a wavelength of 280 to 450 nm was 0.38%, and the refractive index at a wavelength of 280 nm was 2.249. There was no problem with respect to the results of both the adhesiveness and the environmental resistance.

The silicon ratio ([Si]/([Si]+[Hf])) in Comparative example 2 was 0.037. The oxygen atom content in the hafnium silicon oxide layer in Comparative example 2 was 65.1 at %. In addition, the average value of the light absorptance of the two-layer film composed of the hafnium silicon oxide layer and the magnesium fluoride layer in Comparative example 2 at a wavelength of 280 to 450 nm was 0.49%, the average value of the interfacial absorptance at a wavelength of 280 to 450 nm was 0.26%, and the refractive index at a wavelength of 280 nm was 2.131. There was no problem with respect to the results of both the adhesiveness and the environmental resistance.

The silicon ratio ([Si]/([Si]+[Hf])) in Comparative example 3 was 1.000. The oxygen atom content in the hafnium silicon oxide layer in Comparative example 3 was 66.6 at %. In addition, the average value of the light absorptance of the two-layer film composed of the silicon oxide layer and the magnesium fluoride layer in Comparative example 3 at a wavelength of 280 to 450 nm was 0.03%, the average value of the interfacial absorptance at a wavelength of 280 to 450 nm was-0.04%, and the refractive index at a wavelength of 280 nm was 1.514.

With respect to the results of both the adhesiveness and the environmental resistance, peeling of the film was observed.

When Examples 1 to 6 are compared with Comparative examples 1 and 2, the light absorptance in Examples 1 to 6 is lower than the light absorptance in Comparative examples 1 and 2. Regarding the reason for this, an assumed mechanism will be described below. Interfacial absorption occurs in the two-layer film composed of the silicon-free hafnium oxide layer and the magnesium fluoride layer. Consequently, the light absorptance of the two-layer film is 0.38% larger than the total value of the light absorptance of the single hafnium oxide layer and the light absorptance of the single magnesium fluoride layer. As a result, the light absorptance of the two-layer film is 0.60% and is a high absorptance. The reason for this is conjectured that, when there is even a slight lattice defect in the hafnium oxide layer, a fluorine atom located in the vicinity of the interface is taken into the lattice defect of hafnium oxide, and an altered layer of a fluoride having an electronical defect is formed in the vicinity of the interface to the fluoride layer. Therefore, it is conjectured that adding a silicon atom which has a smaller atomic radius than hafnium and which tends to bond to oxygen enables the lattice defect in the oxide to be suppressed from occurring. In Examples 1 to 6, as a result of intensive investigation, a region in which the total light absorptance was decreased by an effect of decreasing the interfacial absorptance due to addition of silicon was found. The first standard of the light absorptance is that the light absorptance is less than the light absorptance of the two-layer film composed of the hafnium oxide layer and the magnesium fluoride layer and, in addition, the interfacial absorptance between the hafnium silicon oxide layer and the magnesium fluoride layer is less than 0.1%. A value of the refractive index is preferably 1.80 or more and is more preferably 2.1 or more. According to Comparative example 3, the two-layer film composed of the silicon oxide layer and the magnesium fluoride layer has poor adhesiveness and environmental resistance, and film cracking or film peeling occurs. According to Comparative example 3, when the silicon content [Si] at % in the hafnium silicon oxide layer is excessively increased, an influence of silicon oxide having a lower refractive index than hafnium oxide is enhanced so as to decrease the refractive index.

Accordingly, it is clear that the layered structure of the hafnium silicon oxide layer and the magnesium fluoride layer in which the silicon ratio ([Si]/([Si]+[Hf])) is within the range of 0.095 or more and 0.902 or less is suitable for an optical element having low light absorptance and high performance. In addition, the oxygen content [O] at % in the hafnium silicon oxide layer is desirably 65.5 at % or more and 67.1% or less. In this regard, the sum of the hafnium content [Hf] at %, the silicon content [Si] at %, and the oxygen content [O] at % is preferably 98.0 at % or more. The hafnium content [Hf] at % is preferably 3.2 at % or more and 29.2 at % or less. The silicon content [Si] at % is preferably 3.1 at % or more and 29.3 at % or less.

The hafnium silicon oxide layer according to the present example contains elements other than hafnium, silicon, and oxygen. For example, the hafnium silicon oxide layer described in the above-described example may contain argon. The argon is derived from the argon gas introduced from the argon gas introduction port 205 during film formation. The argon content [Ar] at % in the hafnium silicon oxide layer can be less than 2.0 at %. In addition, the hafnium silicon oxide layer described in the above-described example may contain zirconium. The zirconium is derived from the sputtering target 209 used during film formation. The zirconium content [Zr] at % in the hafnium silicon oxide layer can be less than 0.14 at %. The zirconium content [Zr] at % in the hafnium silicon oxide layer described in the above-described example was 0.01 to 0.12 at %. The present embodiment is capable of realizing a high refractive index and low light absorptance in spite of containing argon and zirconium. In this regard, the carbon content [C] at % in the hafnium silicon oxide layer described in the above-described example was less than the detection limit.

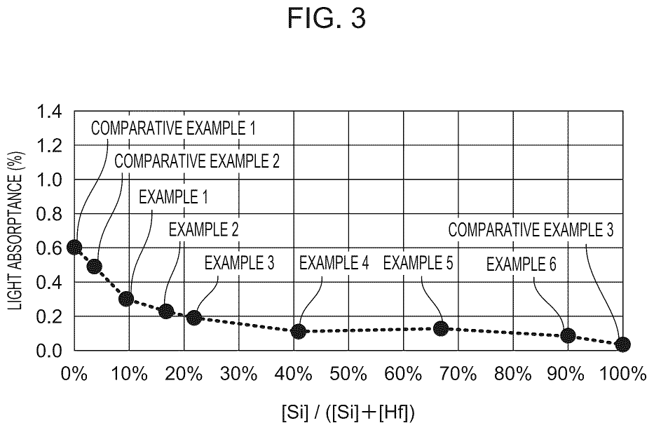

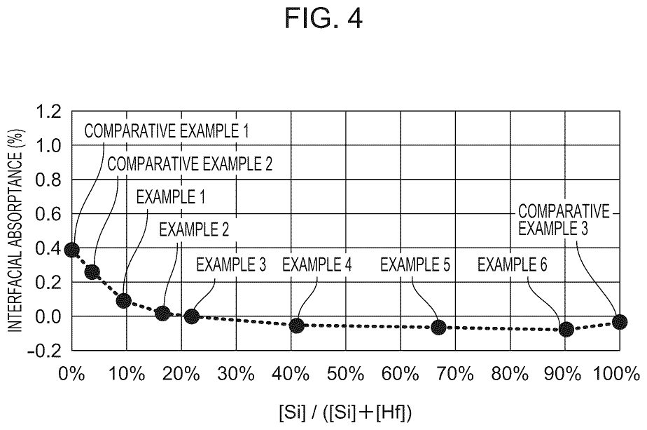

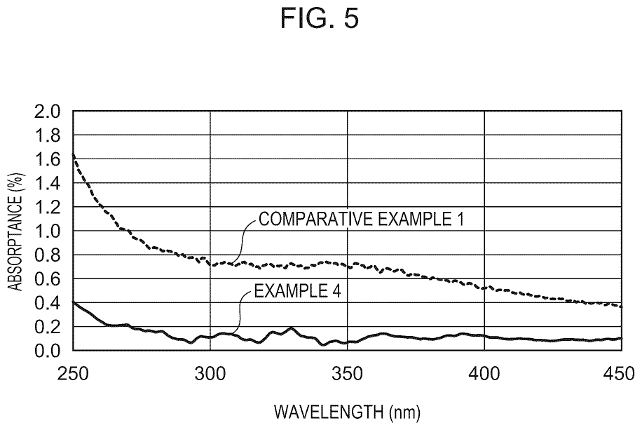

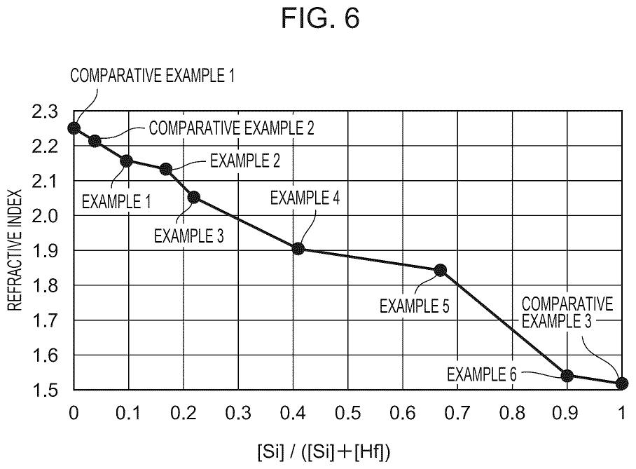

For reference, FIG. 3 is a graph illustrating the average value of the light absorptance at a wavelength of 280 nm to 450 nm versus the silicon content in the oxide film containing hafnium and silicon. FIG. 4 is a graph illustrating the average value of the interfacial absorptance between the hafnium silicon oxide layer and the magnesium fluoride layer at a wavelength of 280 nm to 450 nm versus the silicon content in the oxide film containing hafnium and silicon. FIG. 5 is a graph illustrating the light absorptance characteristics at a wavelength of 280 nm to 450 nm. FIG. 6 is a graph illustrating the refractive index versus the silicon content in the oxide film containing hafnium and silicon.

As is clear from FIG. 3 and FIG. 4, when the silicon ratio ([Si]/([Si]+[Hf])) is 0.095 or more, the light absorptance of the two-layer film composed of the hafnium oxide layer and the magnesium fluoride layer is less than 0.3%, and in addition, the interfacial absorptance between the hafnium silicon oxide layer and the magnesium fluoride layer is less than 0.1%. Further, it is clear that, when the silicon ratio ([Si]/([Si]+[Hf])) is 0.200 or more, the interfacial absorptance between the hafnium silicon oxide layer and the magnesium fluoride layer is less than 0.00%. As illustrated in FIG. 5, in Example 4, the absorptance is significantly decreased in a wavelength range of 280 nm to 450 nm or less. It is clear that a significantly low light absorptance is obtained compared with the two-layer film composed of the hafnium oxide layer and the magnesium fluoride layer in Comparative example 1.

As illustrated in FIG. 6, when the silicon ratio ([Si]/([Si]+[Hf])) is 0.700 or less, it is estimated that the refractive index value of 1.8 or more which is favorable for a high-refractive-index layer is obtained. It is clear that when the silicon ratio is 0.28 or less, the refractive index value of 2.00 or more which is more favorable for a high-refractive-index layer is obtained.

### Example 7 and Comparative Example 4

A specific example in which an optical structure (antireflection structure) was produced on the surface of the transmission type optical element will be described.

Regarding Example 7, an optical structure (antireflection structure) in which hafnium silicon oxide layers serving as the high-refractive-index layer and silicon oxide layers serving as the low-refractive-index layer were alternately stacked, and a magnesium fluoride layer serving as the low-refractive-index layer was arranged as an outermost layer was produced. This corresponds to the configuration of the optical structure 102 illustrated in FIG. 1B. Specifically, a total of 7 layers of the hafnium silicon oxide layers composed of the high-refractive-index layer and the silicon oxide layers serving as the low-refractive-index layer were alternately stacked on a quartz substrate serving as the base member 101 composed of silicon oxide. Subsequently, the magnesium fluoride layer serving as the low-refractive-index layer was stacked as the outermost layer so as to form the optical structure 102. The hafnium silicon oxide layer (high-refractive-index layer) having a silicon ratio ([Si]/([Si]+[Hf])) of 0.410 described in Example 4 was used. In addition, regarding Comparative example 4, an optical structure (antireflection structure) in which hafnium oxide layers serving as the high-refractive-index layer and silicon oxide layers serving as the low-refractive-index layer were alternately stacked, and a magnesium fluoride layer serving as the low-refractive-index layer was arranged as an outermost layer was produced. The hafnium oxide described in Comparative example 1 was used for the hafnium oxide layer serving as the high-refractive-index layer.

In consideration of the purpose of using the optical element 100, to maximize the antireflection characteristics in a wavelength range of 280 nm to 450 nm, the configuration of the optical structure was determined by optimizing the physical film thickness of each layer on the basis of the refractive index values at a wavelength of 280 nm in Example 4 and Comparative example 1.

Table 3 presents specifications of each layer in Example 7.

TABLE 3

| | | Physical film | Refractive |
|---|---|---|---|
| | Material | thickness (nm) | index |
| Eighth layer | magnesium fluoride | 69.0 | 1.390 |
| Seventh layer | hafnium silicon oxide | 32.0 | 1.902 |
| Sixth layer | silicon oxide | 10.0 | 1.495 |
| Fifth layer | hafnium silicon oxide | 72.0 | 1.902 |
| Fourth layer | silicon oxide | 7.5 | 1.495 |
| Third layer | hafnium silicon oxide | 38.0 | 1.902 |
| Second layer | silicon oxide | 27.0 | 1.495 |
| First layer | hafnium silicon oxide | 12.0 | 1.902 |
| Base member | silicon oxide | | 1.495 |

Table 4 presents specifications of each layer in Comparative example 4.

TABLE 4

| | | Physical film | Refractive |
|---|---|---|---|
| | Material | thickness (nm) | index |
| Eighth layer | magnesium fluoride | 78.0 | 1.390 |
| Seventh layer | hafnium oxide | 19.0 | 2.249 |
| Sixth layer | silicon oxide | 31.0 | 1.495 |
| Fifth layer | hafnium oxide | 25.3 | 2.249 |
| Fourth layer | silicon oxide | 29.2 | 1.495 |
| Third layer | hafnium oxide | 21.0 | 2.249 |
| Second layer | silicon oxide | 28.0 | 1.495 |
| First layer | hafnium oxide | 8.0 | 2.249 |
| Base member | silicon oxide | | 1.495 |

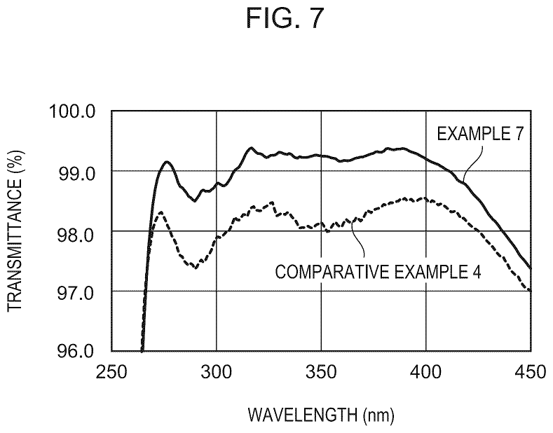

FIG. 7 illustrates the transmittance characteristics of samples in which the optical structures presented in Table 3 and Table 4 were formed on both surfaces of a 2-mm of quartz base material of the optical structures (antireflection structures) in Example 7 and Comparative example 4, respectively. In the wavelength range of 280 nm to 450 nm, the light absorptance of 100 nm of each film material was 0.12% for the hafnium silicon oxide layer, 0.19% for hafnium oxide, about zero (less than or equal to measurement limit) for the silicon oxide, and 0.04% for magnesium fluoride. In this regard, the interfacial absorptance between the hafnium silicon oxide layer and the magnesium fluoride layer was about zero. The interfacial absorptance between the hafnium oxide layer and the magnesium fluoride layer was 0.38%. In addition, the interfacial absorptance between the hafnium silicon oxide layer and the silicon oxide layer and the interfacial absorptance between the hafnium oxide layer and the silicon oxide layer were about zero. The transmission loss due to the light absorptance and the interfacial absorptance of 1 surface of the optical structure (antireflection structure) in Example 7 presented in Table 3 estimated from the above-described light absorptance was 0.16%. On the other hand, the transmission loss due to the light absorptance and the interfacial absorptance of 1 surface of the optical structure (antireflection structure) in Comparative example 4 presented in Table 4 estimated in the same manner from the above-described light absorptance was 0.55%. Regarding the samples illustrated in FIG. 7, a loss of the reflectance is added in addition to the transmission loss due to the light absorptance and the interfacial absorptance. Regarding the loss of 2 surfaces of the optical structure, when the difference in the reflectance due to the difference in the refractive index of the high-refractive-index material is evaluated on the basis of the average value in a wavelength range of 280 nm to 450 nm, Example 7 is 0.38% whereas Comparative example 4 is 0.44% so that there is only a slight difference. As a result, with respect to the average transmittance in a wavelength range of 280 nm to 450 nm, Example 7 in which the hafnium silicon oxide was used is 98.9%, and it is clear that high transmittance is obtained compared with 98.1% in Comparative example 4 in which hafnium oxide was used.

### Example 8 and Comparative Example 5

A specific example in which at least one lens of a lens group included in an exposure apparatus (semiconductor producing apparatus) was coated with an optical structure (antireflection structure) will be described. In Example 8, a lens group in which both surfaces of 20 lenses (a total of 40 surfaces) included in the exposure apparatus were coated with the optical structure (antireflection structure) described in Example 7 was formed. That is, the optical structure (antireflection structure) in which the hafnium silicon oxide layers (high-refractive-index material) and the silicon oxide layers (intermediate-refractive-index material) were alternately stacked, and the outermost layer was magnesium fluoride (low-refractive-index material) was formed on the surfaces of each lens. In this regard, the hafnium silicon oxide layer (high-refractive-index material) that is described in Example 4 and that had a silicon ratio ([Si]/([Si]+[Hf])) which is the ratio of the silicon content [Si] at % to the hafnium content [Hf] at % and the silicon content [Si] at % of 41.0% was used. In addition, in Comparative example 5, a lens group in which both surfaces of 20 lenses (a total of 40 surfaces) were coated with the optical structure (antireflection structure) described in Comparative example 4 was formed. That is, the optical structure (antireflection structure) in which the hafnium oxide layers (high-refractive-index material) and the silicon oxide layers (intermediate-refractive-index material) were alternately stacked, and the outermost layer was magnesium fluoride (low-refractive-index material) was formed on the surfaces of each lens.

Regarding Example 8 and Comparative example 5, to evaluate an aptitude as a lens for an exposure apparatus including an ultraviolet light source, the transmission loss due to light absorption was evaluated using an average value of ultraviolet light with a wavelength of 280 nm to 450 nm. The results are presented in Table 5. Regarding the lens for an exposure apparatus including an ultraviolet light source, the ultraviolet light generated in the ultraviolet light source is applied to an optical structure (antireflection structure) of the lens. Therefore, the ultraviolet light was applied to the optical structure (antireflection structure) in the same manner. Even when a light source of infrared light or visible light is included, the aptitude as an optical element may be evaluated in the same manner by using the light applied to the optical structure (antireflection structure).

TABLE 5

| | | Comparative |
|---|---|---|
| High-refractive-index | Example 8 | example 5 |
| material | HfₓSi_{y}O_{z} | HfO₂ |
| [Si]/([Si] + [Hf]) | 21.9% | 0% |
| Light absorption loss | 0.16% | 0.55% |
| of 1 lens surface | | |
| Light absorption loss | 6.4% | 22.0% |
| of 40 lens surfaces | | |

Regarding the lens group in Example 8, each surface realized a low light absorptance, and the transmission loss was able to be decreased by a large degree. Consequently, the transmission loss of 40 lens surfaces was able to be decreased to 10% or less. On the other hand, regarding Comparative example 5, since the light absorptance, in particular, the interfacial absorptance between the hafnium oxide layer and the magnesium fluoride layer was increased by a large degree compared with Example 8, the transmission loss of 40 lens surfaces was increased to 10% or more.

The lens group in Example 8 has an effect of enhancing the exposure intensity of the exposure apparatus by, for example, being used for an illumination lens group or a projection lens group of the exposure apparatus. Therefore, it is possible to decrease an exposure time so as to improve the processing capability of the exposure apparatus.

### OTHER EMBODIMENTS

The invention is not limited to the above-described embodiments and examples and may be variously modified within the technical concept of the present disclosure.

The high-refractive-index film according to an embodiment is widely applicable to coating of optical elements including a lens, a filter, a mirror, a prism, an image sensor, and a display. Further, the high-refractive-index film is usable for optical apparatuses including the optical element, such as exposure apparatuses, various types of cameras, and interchangeable lenses. These optical apparatuses may include a plurality of optical parts including the optical element coated with a film having a configuration in which a hafnium silicon oxide layer is in contact with a magnesium fluoride layer and, in addition, a holding part (lens barrel) holding a plurality of optical parts. The high-refractive-index film according to an embodiment and a low-refractive-index film having a lower refractive index than the high-refractive-index film being stacked enables a high-performance antireflection structure or a reflection structure to be formed. For example, in an exposure apparatus including an ultraviolet light source, a lens being provided with the antireflection structure according to an embodiment and/or a mirror being provided with the reflection structure according to the embodiment enables the exposure performance of the exposure apparatus which uses the ultraviolet light to be improved.

The above-described embodiment is appropriately changeable within the bounds of not departing from the technical concept. For example, a plurality of embodiments may be combined. In addition, a portion of the items of at least one embodiment may be deleted or replaced. A new item may be added to at least one embodiment.

In this regard, the contents disclosed in the present specification include not only items clearly described in the present specification but also all items that may be grasped from the present specification and drawings attached to the present specification. In addition, the contents disclosed in the present specification includes the complementary set of an individual concept described in the present specification. That is, for example, when there is a description “A is B” in the present specification, even if a description “A is not B” is omitted, it can be said that the present specification discloses “A is not B”. This is because in an instance in which “A is B” is described, it is provided that an instance in which “A is not B” is taken into consideration.

Regarding a specific numerical range exemplified in the present specification, a description “e to f” (e and f are numbers) means “e or more and/or f or less”. In addition, regarding a specific numerical range exemplified in the present specification, when both a range “i to j” and a range “m to n” are described (i, j, m, and n are numbers), a set of a lower limit and an upper limit is not limited to a set of i and j or a set of m and n. For example, lower limits and upper limits of a plurality of sets may be considered in combination. That is, when both a range “i to j” and a range “m to n” are described, a range of “i to n” may be considered, or a range of “m to j” may be considered within the bounds of preventing contradiction from occurring. In this regard, “being e or more” means “being e or being larger than e (more than e)”, and a value larger than e may be adopted rather than e being adopted. In addition, “being f or less” means “being f or being smaller than f (less than f), and a value smaller than f may be adopted rather than f being adopted.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-053578, filed Mar. 28, 2024, which is hereby incorporated by reference herein in its entirety.

What is claimed is:

1. An optical element comprising:
a base member; and
an optical structure disposed on the base member,
wherein the optical structure includes an oxide layer and a fluoride layer,
wherein a distance between the oxide layer and the fluoride layer is smaller than a thickness of the fluoride layer, and
wherein 0.095≤[Si]/([Si]+[Hf])<0.902 is satisfied where [Hf] is a hafnium content (at %) in the oxide layer, and [Si] is a silicon content (at %) in the oxide layer.

2. The optical element according to claim 1,
wherein [Hf]≥3.2 at % is satisfied.

3. The optical element according to claim 1,
wherein [Si]≤29.3 at % is satisfied.

4. The optical element according to claim 1,
wherein [O]≥65.0 at % is satisfied where [O] is an oxygen content (at %) in the one oxide layer.

5. The optical element according to claim 1,
wherein [Si]/([Si]+[Hf])≥0.219 is satisfied.

6. The optical element according to claim 1,
wherein 0.9 at %≤[Ar]≤1.8 at % is satisfied where [Ar] is an argon content (at %) in the oxide layer.

7. The optical element according to claim 1,
wherein 0.01 at %≤[Zr]≤0.12 at % is satisfied where [Zr] is a zirconium content (at %) in the oxide layer.

8. The optical element according to claim 1,
wherein [Hf]+[Si]+[O]≥98.0 at % is satisfied where [O] is an oxygen content (at %) in the oxide layer.

9. The optical element according to claim 1,
wherein the optical structure has an antireflection structure.

10. The optical element according to claim 1,
wherein the optical structure has a reflection structure.

11. The optical element according to claim 1,
wherein the oxide layer is a first oxide layer,
wherein the optical element includes a second oxide layer different from the first oxide layer,
wherein the first oxide layer is located between the fluoride layer and the base member,
wherein the second oxide layer is located between the first oxide layer and the base member, and
wherein a dielectric layer having a lower refractive index than the first oxide layer and the second oxide layer is located between the first oxide layer and the second oxide layer.

12. The optical element according to claim 11,
further comprising a third oxide layer between the second oxide layer and the base member,
wherein a dielectric layer having a lower refractive index than the second oxide layer and the third oxide layer is located between the second oxide layer and the third oxide layer.

13. The optical element according to claim 11,
wherein the dielectric layer is a silicon oxide layer.

14. The optical element according to claim 1,
wherein the oxide layer is a first oxide layer,
wherein the optical element includes a second oxide layer different from the first oxide layer,
wherein the fluoride layer is a first fluoride layer,
wherein the optical element includes a second fluoride layer different from the first fluoride layer,
wherein the first fluoride layer is located between the first oxide layer and the base member,
wherein the second oxide layer is located between the first fluoride layer and the base member, and
wherein the second fluoride layer is located between the second oxide layer and the base member.

15. The optical element according to claim 1,
wherein a surface of the base member on the optical structure side is a concave surface or a convex surface.

16. The optical element according to claim 1,
wherein a main component of the base member is silicon oxide or calcium fluoride.

17. The optical element according to claim 11,
wherein the optical element is a lens, a mirror, or a prism.

18. An apparatus comprising:
the optical element according to claim 1; and
a holding part to hold the optical element.

19. An apparatus comprising:
the optical element according to claim 1; and
a light source to generate ultraviolet light applied to the optical structure.

20. The apparatus according to claim 18, comprising:
a reticle stage to be equipped with a reticle; and
a substrate stage to be equipped with a substrate,
wherein ultraviolet light is to be applied to the substrate through the reticle and the optical element.
